(19) United States
(12) Patent Application Publication
(10) Pub. No.: US 2015/0049218 A1
(43) Pub. Date: Feb. 19, 2015

(54) INFORMATION PROCESSING METHODS AND ELECTRONIC DEVICES

(71) Applicant: Lenovo (Beijing) Limited, Beijing (CN)

(72) Inventors: Rongyao Fu, Beijing (CN); Qiang Zhang, Beijing (CN); Haidong Lu, Beijing (CN); Guanghua Zhou, Beijing (CN); Jie Yang, Beijing (CN)

(73) Assignee: Lenovo (Beijing) Limited, Beijing (CN)

(21) Appl. No.: 14/227,109

(22) Filed: Mar. 27, 2014

(30) Foreign Application Priority Data
Aug. 16, 2013 (CN) 201310359388.X

(51) Int. Cl. H04N 5/235; H04N 5/232; H04N 5/225

(52) U.S. Cl. CPC H04N 5/235; H04N 5/2256; H04N 5/23229
USPC 348/239

(57) ABSTRACT

The present disclosure provides a method for processing information and an electronic device. The method includes: obtaining a first image, which is captured in a first direction when illuminating an object to be recognized with a first flash lighting parameter, wherein the first image comprises a first object image and a first spot image corresponding to the first flash lighting parameter, wherein the first spot image is overlapped with the first object image at a first position; obtaining a second image, which is captured in a second direction different from the first direction when illuminating the object to be recognized with a second flash lighting parameter, wherein the second image comprises a second object image and a second spot image corresponding to the second flash lighting parameter, wherein the second spot image is overlapped with the second object image at a second position different from the first position; removing the first spot image from the first image to obtain a third image and removing the second spot image from the second image to obtain a fourth image; and merging the third and fourth images to obtain a fifth image comprising a third object image without the first and second spot images at the first and second positions.

### TECHNICAL FIELD

The present disclosure relates to electronic technologies, more particularly to information processing methods and electronic devices.

### BACKGROUND

Nowadays, people may enjoy comfortable life along with the development of science and technology through various types of the electronic devices. For example, an image of a target object may be captured by an image capturing apparatus provided in an electronic device and thus the function and purpose of the object are recognized by the electronic device. As an example, a display screen of the electronic device may be implemented as a table top. When a cup is placed on such display table, a camera on the display table will capture a general profile of the cup and thus the objected placed on the display table is recognized as a cup. Of cause the electronic device has a capability of recognizing other objects such as a dice or a hand phone.

However when practicing the present disclosure, the inventor found that the above approach has at least following technical problems.

1. The profile of the object is captured by the image capturing apparatus which illuminates the object by a flash lamp. Due to the presence of the flash lamp, a spot is usually formed in the obtained image of the object by the light reflected by the flash lamp, causing it difficult to obtain an accurate profile of the object, i.e. there is a problem that the image of the target object is extracted inaccurately.

2. Since there is a problem that the image of the target object is extracted inaccurately, it is desirable to isolate spot in the obtained target image in order to achieve a more accurate extraction of the target object. However there would be a loss in the image information for the obtained image of the target object after the spot is isolated.

### SUMMARY

By providing information processing method and electronic devices, embodiments of the present disclosure may solve the problem that the image of the target object is extracted inaccurately by the image capturing apparatus and achieve a technical effect of obtaining the image of the target object accurately.

In an aspect, embodiments of the present disclosure provide a method for processing information in an electronic device, wherein the method includes: obtaining a first image, which is captured in a first direction when illuminating an object to be recognized with a first flash lighting parameter, wherein the first image includes a first object image and a first spot image corresponding to the first flash lighting parameter, wherein the first spot image is overlapped with the first object image at a first position; obtaining a second image, which is captured in a second direction different from the first direction when illuminating the object to be recognized with a second flash lighting parameter, wherein the second image includes a second object image and a second spot image corresponding to the second flash lighting parameter, wherein the second spot image is overlapped with the second object image at a second position different from the first position; removing the first spot image from the first image to obtain a third image and removing the second spot image from the second image to obtain a fourth image; and merging the third and fourth images to obtain a fifth image including a third object image without the first and second spot images at the first and second positions.

Preferably, obtaining a first image may include: directing an image capturing apparatus of the electronic device to the first direction by controlling a rotator connected to the image capturing apparatus in the electronic device; and capturing the first image by the image capturing apparatus.

Preferably, the third image may include the first object image and a first blank image which is overlapped with the first object image at the first position.

Preferably, the fourth image may include the second object image and a second blank image which is overlapped with the second object image at the second position.

Preferably, merging the third and fourth images to obtain a fifth image may include: filling the second blank image located at the second position with a third position image located at a third position in the third image, wherein the third position image is a part of the first object image and the third position corresponds to the second position; filling the first blank image located at the first position with a fourth position image located at a fourth position in the fourth image, wherein the fourth position image is a part of the second object image, the fourth position corresponds to the first position, and the fourth position image is different from the third position image; and obtaining the fifth image having the fourth position image at the first position and the third position image at the second position.

In another aspect, embodiments of the present disclosure provide an electronic device includes: a first obtaining unit configured to obtain a first image, which is captured in a first direction when illuminating an object to be recognized with a first flash lighting parameter, wherein the first image includes an first object image and a first spot image corresponding to the first flash lighting parameter, wherein the first spot image is overlapped with the first object image at a first position; a second obtaining unit configured to obtain a second image, which is captured in a second direction different from the first direction when illuminating the object to be recognized with a second flash lighting parameter, wherein the second image includes a second object image and a second spot image corresponding to the second flash lighting parameter, wherein the second spot image is overlapped with the second object image at a second position different from the first position; a removing unit configured to remove the first spot image from the first image to obtain a third image and remove the second spot image from the second image to obtain a fourth image; and a merging unit configured to merge the third and fourth images to obtain a fifth image including a third object image without the first and second spot images at the first and second positions.

Preferably, the first obtaining unit may be an image capturing unit including: an image capturing apparatus provided on the electronic device; and a rotator provided in the electronic device and connected to the image capturing apparatus; wherein the image capturing apparatus is directed to the first direction by controlling the rotator and the first image is captured by the image capturing apparatus.

Preferably, the third image may include the first object image and a first blank image which is overlapped with the first object image at the first position.

Preferably, the fourth image may include the second object image and a second blank image which is overlapped with the second object image at the second position.

Preferably, the merging unit may include: a first filling sub-unit configured to fill the second blank image located at the second position with a third position image located at a third position in the third image, wherein the third position image is a part of the first object image and the third position corresponds to the second position; a second filling sub-unit configured to fill the first blank image located at the first position with a fourth position image located at a fourth position in the fourth image, wherein the fourth position image is a part of the second object image, the fourth position corresponds to the first position, and the fourth position image is different from the third position image; and a first obtaining sub-unit configured to obtain the fifth image having the fourth position image at the first position and the third position image at the second position.

Embodiments of the present disclosure have at least the following technical effects or advantageous.

1. The profile of the object is captured by the image capturing apparatus which illuminates the object by a flash lamp. Due to the presence of the flash lamp, a spot is usually formed in the obtained image of the object by the light reflected by the flash lamp, causing it difficult to obtain an accurate profile of the object, i.e. there is a problem that the image of the target object is extracted inaccurately. Such problem is overcome by embodiments of the present disclosure through obtaining a first image in a first direction, obtaining a second image in a second direction, and combining the first and second images to eliminate the spot. Accordingly, an accurate extraction of the target object is achieved.

2. Since there is a problem that the image of the target object is extracted inaccurately, it is desirable to isolate spot in the obtained target image in order to achieve a more accurate extraction of the target object. However there would be a loss in the image information for the obtained image of the target object after the spot is isolated. Such problem is overcome by embodiments of the present disclosure through removing a first spot image from a first image, removing a second spot image from a second image, and then using the second image to fill the blank formed by removing the first spot image from the first image and using the first image to fill the blank formed by removing the second spot image from the second image in order to combining the first image with the second image. In this manner, inaccurate extraction of the target object is avoided. There is no information loss in the extracted image of the target object while the spot is eliminated.

### BRIEF DESCRIPTION OF THE DRAWINGS

FIG. 1 is a flowchart illustrating a method for processing information according to an embodiment of the present disclosure;

FIG. 2 is a schematic diagram showing an image of a target object having a blank image at a first position when the target object is a dice according to an embodiment of the present disclosure;

FIG. 3 is a schematic diagram showing an image of a target object having a blank image at a second position when the target object is a dice according to an embodiment of the present disclosure;

FIG. 4 is a schematic diagram showing a complete image of a target object obtained when the target object is a dice according to an embodiment of the present disclosure;

FIG. 5 is a block diagram showing an electronic device according to an embodiment of the present disclosure.

### DETAILED DESCRIPTION OF THE PREFERRED EMBODIMENTS

By providing a method for processing information and an electronic device, embodiments of the present disclosure may solve the problem that the image of the target object is extracted inaccurately by the image capturing apparatus and achieve an technical effect of obtaining the image of the target object accurately.

In order to solve the problem that the image of the target object is extracted inaccurately by the image capturing apparatus, the principle of the present disclosure is as follows.

When image information of the target object is captured by the image capturing apparatus, it is desirable to perform capturing in coordinate with a flash lamp provided in the image capturing apparatus. Therefore it is possible to obtain images of the target object in different directions. Firstly, an image capturing unit is controlled to obtain a first image of the target object in a first direction wherein the first image having a first spot image at a first position. Next, a rotator connected to the image capturing unit is adjusted such that the image capturing unit is directed to a second direction different from the first direction. A second image of the target object is obtained in the second direction. The second image has a spot image at a second position.

The target object is not varied between the first and second images obtained as above. However the position of the spot is varied between the first and second images obtained as above because the first and second images are obtained in different directions.

The first and second spot images are removed from the first and second images respectively to obtain a third image having a blank at the first position and a fourth image having a blank at the second position.

The third image is combined with the fourth image to obtain a complete image of the target object without spot.

In the following, a detail description will be given to the present disclosure by means of its specific embodiments with reference to the drawings for better understanding of the present disclosure.

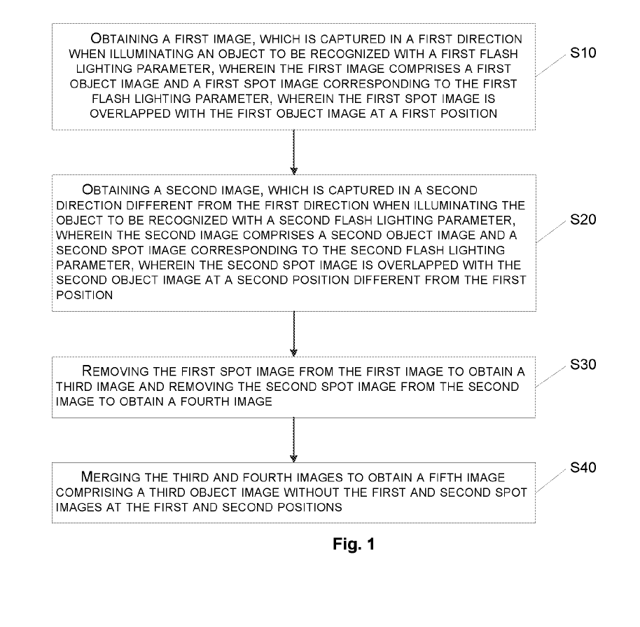

As shown in FIG. 1, a method for processing information in an electronic device, wherein the method includes following steps.

Step S10: obtaining a first image, which is captured in a first direction when illuminating an object to be recognized with a first flash lighting parameter, wherein the first image includes a first object image and a first spot image corresponding to the first flash lighting parameter, wherein the first spot image is overlapped with the first object image at a first position.

Step S20: obtaining a second image, which is captured in a second direction different from the first direction when illuminating the object to be recognized with a second flash lighting parameter, wherein the second image includes a second object image and a second spot image corresponding to the second flash lighting parameter, wherein the second spot image is overlapped with the second object image at a second position different from the first position;

Step S30: removing the first spot image from the first image to obtain a third image and removing the second spot image from the second image to obtain a fourth image.

Step S40: merging the third and fourth images to obtain a fifth image including a third object image without the first and second spot images at the first and second positions.

In step S10, obtaining a first image includes: directing an image capturing apparatus of the electronic device to the first direction by controlling a rotator connected to the image capturing apparatus in the electronic device.

In step S20, obtaining a second image includes: directing the image capturing apparatus of the electronic device to the second direction by controlling the rotator connected to the image capturing apparatus in the electronic device.

In an embodiment, generally the luminance of the flash lamp is constant. The first flash lighting parameter as referred herein means that the size of the spot formed in the first image is not large enough to cover entire of the captured target object. In obtaining the first image, the rotator connected to the image capturing apparatus is controlled to choose an appropriate first direction in which the image of the target object is extracted. The rotator is not only used for obtaining images of one object in different directions, but also used for obtaining images of other objects by controlling the rotator when different target objects are placed at different positions.

Next, in obtaining the second images, the rotator connected to the image capturing apparatus is controlled to choose an appropriate second direction in which the image of the target object is extracted. The second direction is different from the first direction.

For example, the target object may be a dice. In this case, the obtained first image is an image representing a face with number 6 of the dice. A first spot image is present on upper right of the face with number 6 in this image. The first spot image covers a part of the face with number 6 of the dice, which is located on upper right of the face with number 6 of the dice. Likewise, the obtained second image is also an image representing a face with number 6 of the dice and a second spot image is present under the upper right of the face with number 6 in this image. The first spot image is obtained with a first flash lighting parameter and the second spot image is obtained with a second lash lighting parameter. When the first flash lighting parameter is different from the second flash lighting parameter, the size of the obtained first spot image is different from that of the second of the obtained second spot image. However when the first and second spot images are placed in one and the same image, the area of the first spot images is not overlapped with that of the second spot image. If an overlap between the first and second spot images is detected, it is necessary to recapture the second image.

Through the two steps as described above, the first image having the first spot and the second image having the second spot are obtained. Next, process proceeds to step S30 in which the first spot image is removed from the first image to obtain a third image and the second spot image is removed from the second image to obtain a fourth image.

At step S30, the third image may include the first object image and a first blank image which is overlapped with the first object image at the first position. The fourth image may include the second object image and a second blank image which is overlapped with the second object image at the second position.

In an embodiment, removing the first spot image from the first image may include: eliminating the spot image by Photoshop or any other PS software. In this manner, the third and fourth images having respective blanks at respective positions where respective spots are removed may be obtained. For example, a first image having a circular shaped blank area at its upper right for of the face with to number 6 of the dice is obtained and a second image having another circular shaped blank area under its upper right for the face with number 6 of the dice is obtained. The two circular shaped blank areas are not overlapped with each other when placed on one and the same image of the dice.

After step S30, i.e. after the image having spot removed and thus having a blank image at the spot position is obtained, the process proceeds to step S40 in which the third and fourth images are merged to obtain a fifth image including a third object image without the first and second spot images at the first and second positions.

Particularly, merging the third and fourth images to obtain a fifth image includes: filling the second blank image located at the second position with a third position image located at a third position in the third image, wherein the third position image is a part of the first object image and the third position corresponds to the second position; filling the first blank image located at the first position with a fourth position image located at a fourth position in the fourth image, wherein the fourth position image is a part of the second object image, the fourth position corresponds to the first position, and the fourth position image is different from the third position image; and obtaining the fifth image having the fourth position image at the first position and the third position image at the second position.

In an embodiment, the third image has the first blank image at the first position and the fourth image has the second blank image at the second position. The first position is different from the second position and the first position area is not overlapped with the second position area. When the third and fourth images are merged, it will found that the first blank image in the third image is filled with a part of the fourth image at corresponding position while the second blank image in the fourth image is filled with a part of the third image at corresponding position.

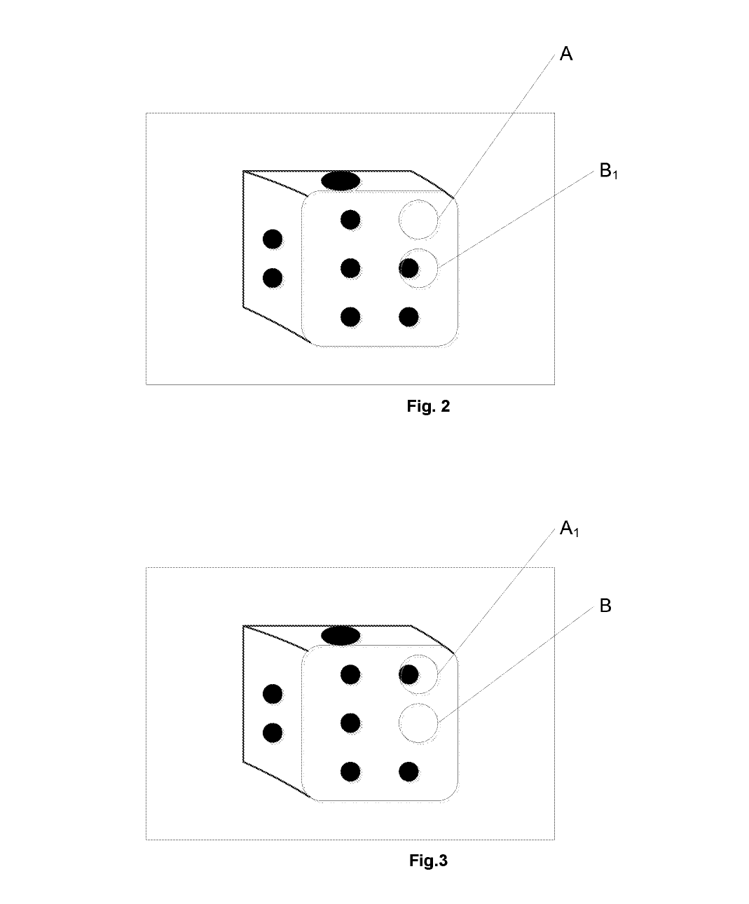

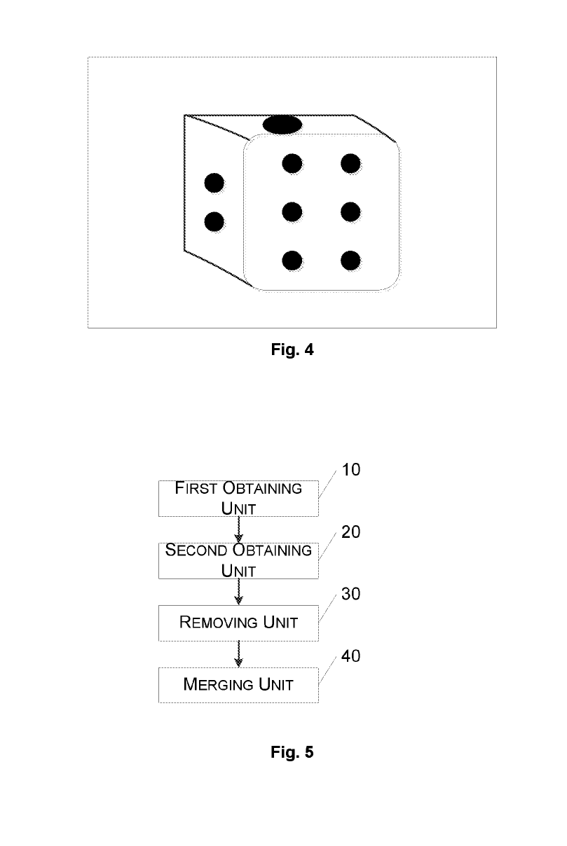

In case of the target object is a dice as described above, a blank image is present in an area A at upper right of the target object being a dice in the first image with the first spot removed as shown in FIG. 2, and a blank image is present in an area B under the upper right of the target object being a dice in the second image with the second spot removed as shown in FIG. 3. After the first and second images are merged, a complete image of a face of the dice is obtained. As area A of the first image is filled with a part of the second image at corresponding position A₁, area B of the second image is filled with a part of the first image at corresponding position B₁, and the rest of the first and second images are coincided with each other, the resulting image is a complete image without spot. The complete image is shown as in FIG. 4.

As shown in FIG. 5, embodiments of the present disclosure provide an electronic device including: a first obtaining unit 10 configured to obtain a first image, which is captured in a first direction when illuminating an object to be recognized with a first flash lighting parameter, wherein the first image includes an first object image and a first spot image corresponding to the first flash lighting parameter, wherein the first spot image is overlapped with the first object image at a first position; a second obtaining unit 20 configured to obtain a second image, which is captured in a second direction different from the first direction when illuminating the object to be recognized with a second flash lighting parameter, wherein the second image includes a second object image and a second spot image corresponding to the second flash lighting parameter, wherein the second spot image is overlapped with the second object image at a second position different from the first position; a removing unit 30 configured to remove the first spot image from the first image to obtain a third image and remove the second spot image from the second image to obtain a fourth image; and a merging unit 40 configured to merge the third and fourth images to obtain a fifth image including a third object image without the first and second spot images at the first and second positions.

Preferably, the first obtaining unit 10 may be an image capturing unit including: an image capturing apparatus provided on the electronic device; and a rotator provided in the electronic device and connected to the image capturing apparatus; wherein the image capturing apparatus is directed to the first direction by controlling the rotator and the first image is captured by the image capturing apparatus.

Preferably, the third image may include the first object image and a first blank image which is overlapped with the first object image at the first position.

Preferably, the fourth image may include the second object image and a second blank image which is overlapped with the second object image at the second position.

Preferably, the merging unit 40 may include: a first filling sub-unit configured to fill the second blank image located at the second position with a third position image located at a third position in the third image, wherein the third position image is a part of the first object image and the third position corresponds to the second position; a second filling sub-unit configured to fill the first blank image located at the first position with a fourth position image located at a fourth position in the fourth image, wherein the fourth position image is a part of the second object image, the fourth position corresponds to the first position, and the fourth position image is different from the third position image; and a first obtaining sub-unit configured to obtain the fifth image having the fourth position image at the first position and the third position image at the second position.

Embodiments of the present disclosure have at least the following technical effects or advantageous.

1. The profile of the object is captured by the image capturing apparatus which illuminates the object by a flash lamp. Due to the presence of the flash lamp, a spot is usually formed in the obtained image of the object by the light reflected by the flash lamp, causing it difficult to obtain an accurate profile of the object, i.e. there is a problem that the image of the target object is extracted inaccurately. Such problem is overcome by embodiments of the present disclosure through obtaining a first image in a first direction, obtaining a second image in a second direction, and combining the first and second images to eliminate the spot. Accordingly, an accurate extraction of the target object is achieved.

2. Since there is a problem that the image of the target object is extracted inaccurately, it is desirable to isolate spot in the obtained target image in order to achieve a more accurate extraction of the target object. However there would be a loss in the image information for the obtained image of the target object after the spot is isolated. Such problem is overcome by embodiments of the present disclosure through removing a first spot image from a first image, removing a second spot image from a second image, and then using the second image to fill the blank formed by removing the first spot image from the first image and using the first image to fill the blank formed by removing the second spot image from the second image in order to combining the first image with the second image. In this manner, inaccurate extraction of the target object is avoided. There is no information loss in the extracted image of the target object while the spot is eliminated.

It will be appreciated by those skilled in the art that embodiments of the present disclosure may provide a method, a system, or a computer product. Accordingly, the present disclosure may be implemented in hardware, software, or combination thereof. Furthermore, the present disclosure may be implemented as a computer product carried out on one or more computer-readable storage mediums (including but not limited to magnetic disc memory, CD-ROM, optical memory and the like) having computer executable program codes recorded thereon.

The present disclosure is described with reference to flowcharts and/or block diagrams of methods, devices (systems) and computer products according to embodiments of the present disclosure. It should be understood that each flow in a flowcharts and/or each block in a block diagram and/or combination thereof may be implemented by computer program instructions. Such computer program instructions may be provided to a general-purpose computer, a special-purpose computer, a built-in processor or a processor of other programmable data process device to provide a machine, such that means for performing functions as specified in one or more flows in a flowchart and/or one or more blocks in a block diagram may be produced by the computer or the processor of other programmable data process device.

The computer program instructions may be also stored in a computer readable storage, which can direct the computer or other programmable data processing devices to operate in a specific manner. To this end, instructions stored in the computer readable storage may produce article of manufacture including instructions means. The instructions means implement functions as specified in one or more flows in a flowchart and/or one or more blocks in a block diagram.

The computer program instructions may be also loaded into a computer or other programmable data processing devices, so as to execute a serial of operation steps on the computer or other programmable data processing devices to produce actions captured by the computer. To this end, instructions executed on the computer or other programmable devices may be provided to implement functions as specified in one or more flows in a flowchart and/or one or more blocks in a block diagram.

Although preferred embodiments of the present disclosure have been described herein, many variations and modifications are obvious for those skilled in the art according to the teachings of the present disclosure. Therefore the following claims are intended to cover the preferred embodiments of the present disclosure and all the variations and modifications falling within the scope of the present disclosure.

Obviously, various variations and modifications can be made by those skilled in the art without departing from the principle of the present disclosure. These variations and modifications should be encompassed by the scope of the present disclosure which is defined by the claims.

What is claimed is:

1. A method for processing information in an electronic device, wherein the method comprises:
obtaining a first image, which is captured in a first direction when illuminating an object to be recognized with a first flash lighting parameter, wherein the first image comprises a first object image and a first spot image corresponding to the first flash lighting parameter, wherein the first spot image is overlapped with the first object image at a first position;
obtaining a second image, which is captured in a second direction different from the first direction when illuminating the object to be recognized with a second flash lighting parameter, wherein the second image comprises a second object image and a second spot image corresponding to the second flash lighting parameter, wherein the second spot image is overlapped with the second object image at a second position different from the first position;
removing the first spot image from the first image to obtain a third image and removing the second spot image from the second image to obtain a fourth image; and
merging the third and fourth images to obtain a fifth image comprising a third object image without the first and second spot images at the first and second positions.

2. The method according to claim 1, wherein obtaining a first image comprises: directing an image capturing apparatus of the electronic device to the first direction by controlling a rotator connected to the image capturing apparatus in the electronic device; and
capturing the first image by the image capturing apparatus.

3. The method according to claim 1, wherein the third image comprises the first object image and a first blank image which is overlapped with the first object image at the first position.

4. The method according to claim 3, wherein the fourth image comprises the second object image and a second blank image which is overlapped with the second object image at the second position.

5. The method according to claim 4, wherein merging the third and fourth images to obtain a fifth image comprises:
filling the second blank image located at the second position with a third position image located at a third position in the third image, wherein the third position image is a part of the first object image and the third position corresponds to the second position;
filling the first blank image located at the first position with a fourth position image located at a fourth position in the fourth image, wherein the fourth position image is a part of the second object image, the fourth position corresponds to the first position, and the fourth position image is different from the third position image; and
obtaining the fifth image having the fourth position image at the first position and the third position image at the second position.

6. An electronic device comprises:
a first obtaining unit configured to obtain a first image, which is captured in a first direction when illuminating an object to be recognized with a first flash lighting parameter, wherein the first image comprises an first object image and a first spot image corresponding to the first flash lighting parameter, wherein the first spot image is overlapped with the first object image at a first position;
a second obtaining unit configured to obtain a second image, which is captured in a second direction different from the first direction when illuminating the object to be recognized with a second flash lighting parameter, wherein the second image comprises a second object image and a second spot image corresponding to the second flash lighting parameter, wherein the second spot image is overlapped with the second object image at a second position different from the first position;
a removing unit configured to remove the first spot image from the first image to obtain a third image and remove the second spot image from the second image to obtain a fourth image; and
a merging unit configured to merge the third and fourth images to obtain a fifth image comprising a third object image without the first and second spot images at the first and second positions.

7. The electronic device according to claim 6, wherein the first obtaining unit is an image capturing unit comprising:
an image capturing apparatus provided on the electronic device; and
a rotator provided in the electronic device and connected to the image capturing apparatus;
wherein the image capturing apparatus is directed to the first direction by controlling the rotator and the first image is captured by the image capturing apparatus.

8. The electronic device according to claim 6, wherein the third image comprises the first object image and a first blank image which is overlapped with the first object image at the first position.

9. The electronic device according to claim 8, wherein the fourth image comprises the second object image and a second blank image which is overlapped with the second object image at the second position.

10. The electronic device according to claim 6, wherein the merging unit comprises:
a first filling sub-unit configured to fill the second blank image located at the second position with a third position image located at a third position in the third image, wherein the third position image is a part of the first object image and the third position corresponds to the second position;
a second filling sub-unit configured to fill the first blank image located at the first position with a fourth position image located at a fourth position in the fourth image, wherein the fourth position image is a part of the second object image, the fourth position corresponds to the first position, and the fourth position image is different from the third position image; and
a first obtaining sub-unit configured to obtain the fifth image having the fourth position image at the first position and the third position image at the second position.
